(19) United States
(12) Patent Application Publication
(10) Pub. No.: US 2026/0123793 A1
(43) Pub. Date: May 7, 2026

(54) POULTRY VERTICAL ROASTING RACK

(71) Applicant: Spanek, Inc., Saratoga, CA (US)

(72) Inventor: Denis C. Spanek, Saratoga, CA (US)

(21) Appl. No.: 19/376,000

(22) Filed: Oct. 31, 2025

Related U.S. Application Data
(60) Provisional application No. 63/716,775, filed on Nov. 6, 2024.

(51) Int. Cl. A47J 43/18

(52) U.S. Cl. CPC A47J 43/18

(57) ABSTRACT

A poultry vertical roasting rack including method for making and using the rack to cook poultry with a standard oven. The rack consists of at least a round base, center ring and top ring, and having a plurality of wire rods distributed around the base each in a vertical plane and curving inward and then upwards from the base towards and through the center ring to the top ring to define a cylinder upon which to vertically mount a poultry carcass such as chicken, duck or turkey for roasting in a standard oven.

### CROSS-REFERENCE TO RELATED DOCUMENTS

The present invention claims priority to provisional patent application serial number 63/716,775 filed on November 6, 2024.

### BACKGROUND

The invention relates to a new and improved rack for vertically supporting poultry during roasting. The rack supports poultry in an oven or barbeque so that the meat is cooked evenly while retaining its natural juices. Prior art racks allow oven heated air to circulate within the body cavity to cook the meat evenly from the inside and the outside. However, the prior art racks generally fail to adequately sear the interior of the carcass to retain natural juices and are, instead, focused on allowing the natural juices to escape. In accordance with the present invention, searing heat is conducted quickly and evenly through the vertically oriented wire rods into the interior of the carcass during the initial stages of roasting thus searing the interior meat to prevent natural juices from escaping and drying out the meat during the remainder of the roasting process.

### SUMMARY

Dressed poultry is supported vertically on the inventive roasting rack with the opening of the body cavity facing downward. Thus, heat is directed both interiorly and exteriorly of the poultry causing uniform cooking. Prior art racks are designed to allow natural juices to drain out the bottom opening. While it is inevitable that some juices will drain, Applicant has discovered through extensive trial and error that the inventive rack, by increasing the conductivity of heat through the vertically oriented wire extending within the body cavity and/or by increasing the surface area of the wire positioned adjacent and in contact with the interior meat, effectively sears the interior meat within the first 20-30 minutes of roasting and is thus effective in sealing in the natural juices which provide greater flavor and texture to the roasted meat. To conduct adequate heat through the vertical wire rods, the bottom portion of the vertically extending wire rods must remain exposed to oven heat, the vertical wire rods must be of appropriate gauge and material for conducting the searing heat, and the number and/or surface area of the wire rods must be increased over prior art designs. Use of this inventive design results in decreasing the amount of needed cooking time. Sealing the natural juices of the poultry increases the natural flavor and enhances the texture of the meat.

The inventive poultry roasting rack includes top, center and base horizontally oriented rings mounted to a plurality of vertical rods, each rod having upper, central and lower portions. Each of the horizontally oriented rings have outwardly facing, inwardly facing, top facing and bottom facing surfaces, also referred to as circumferences. The vertical rods are spaced evenly around the base ring, preferably attached at the top facing surface of the base ring but could be attached at the inner facing surface. The distal ends of the vertical rods where they attach with the base ring may have substantially horizontally oriented feet. Each of the rods is spaced evenly around the inwardly facing surface or circumference of the center and top ring as they ascend upwards towards the top ring. Each of the rods extends inwardly and upwardly from the base ring in a substantially vertical hyperbolic arc, connecting at the center portion with the center ring and at the top portion with the top ring. The base rings is substantially larger in diameter than the center and top rings. The curvature of the bottom portion of the rods extending from the base ring inwardly and then upwardly at a substantially horizontal angle of less than 60 degrees, and preferably between 5 and 45 degrees, relative to the horizontally oriented base, center and top rings so to provide an exposed area of the lower portion of the wire of approximately one or more inches when a poultry carcass is positioned vertically down onto the rack for roasting, and wherein the bottom portion of the rods remain substantially exposed to heat during a roasting process thus serving to conduct heat upward toward the center ring and into the interior of the poultry carcass during roasting. In some embodiments, the curvature of the bottom portion of the wire extends upward at an angle of from 5 to 60 degrees before curving upward in a hyperbolic arc toward the center ring. In some embodiments, the middle portion of the rods extend upward between the center and top rings at an angle of 50 to 90 degrees. Each of the wire members (base ring, center ring, top ring, and vertical wire rods) is made of material of strong conductive material (such as tempered steel) appropriate for use in oven roasting. In alternative embodiments, as shown, one or more additional removable lower rings may be optionally positioned between the base and center rings to ensure proper searing to lower portions of the poultry that are more difficult to heat evenly. In alternative embodiments, the one or more additional rings may be fixed to the lower portion of the rods. In alternative embodiments, one or more additional rings may be removably positioned or fixedly placed between the top and center rings.

A principal inventive feature of the invention is that the wire rods extending upward within the poultry body cavity are contoured substantially horizontally, preferably at and angle of 5 to 45 degrees immediate adjacent the connection with the bottom ring or, if the bottom portions have substantially horizontal feet, extending from the fee. This is to ensure enough exposure of the bottom portion of the wire to adequately retain and conduct searing heat with those racks used for larger poultry (such as turkey) having a relatively larger horizontally inclined extension upwards toward the center ring. Another inventive feature is that the wire extending within the body cavity is made of a more conductive gauge and material than many prior art designs. For example, prior art designs may be made of relatively low conductive material such as stainless steel while the present invention utilizes more conductive material such as tempered steel. Another inventive feature is that the surface area of the wire extending within the body cavity is increased by way of adding more wires and/or by curving the wires horizontally to provide increased surface contact with the interior carcass meat of the mounted poultry while still allowing for the oven air heat to penetrate within the body cavity and sear the interior meat.

A method for making the invention includes fashioning the wire members including base ring, center ring, top ring, optional bottom ring(s) and wire rods, then positioning and welding the wire members in place and then applying nickel plating or other coating which does not impede the searing process. A method for using includes mounting the poultry vertically on the rack such that the lower portion of the wire rods are exposed, placing the poultry mounted rack in an oven, and roasting for an appropriate period of time. The method includes providing one or more optional and detached rings placed over the top ring and sliding down onto the lower portion of the rack to provide increased searing capacity to the lower portion of the poultry.

Other inventive features will become apparent upon reading the following specification and referring to the accompanying drawings in which similar characters of reference represent corresponding parts in each of the several views.

### DRAWINGS

FIG. 1 is a perspective view of a first embodiment of the inventive vertical poultry roasting rack.

FIG. 2 is a bottom perspective view of the first embodiment of the inventive vertical poultry roasting rack.

FIG. 3 is a top perspective view of the first embodiment of the inventive vertical poultry roasting rack.

FIG. 4 is a schematic side elevation view of a variation of the first embodiment of the inventive vertical poultry roasting rack.

FIG. 5 is a perspective view of the first embodiment of the inventive vertical poultry roasting rack as shown in FIG. 1 supporting a mounted poultry during roasting.

FIG. 6 is a perspective view of a second embodiment of the inventive vertical poultry roasting rack.

FIG. 7 is a bottom perspective view of the second embodiment of the inventive vertical poultry roasting rack.

FIG. 8 is a top perspective view of the second embodiment of the inventive vertical poultry roasting rack.

FIG. 9 is a schematic side elevation view of a variation of the second embodiment of the inventive vertical poultry roasting rack.

FIG. 10 is a perspective view of a second embodiment of the inventive vertical poultry roasting rack shown in FIG. 6 supporting a mounted poultry during roasting.

FIG. 11 is a flow chart showing the steps for making a first embodiment of the inventive vertical poultry roasting rack shown in FIGS. 1-6

FIG. 12 is a flow chart showing the steps for making a second embodiment of the inventive vertical poultry roasting rack shown in FIGS. 7-10.

FIG. 13 is a flow chart showing the steps for using the inventive vertical poultry roasting rack.

### DETAILED DESCRIPTION

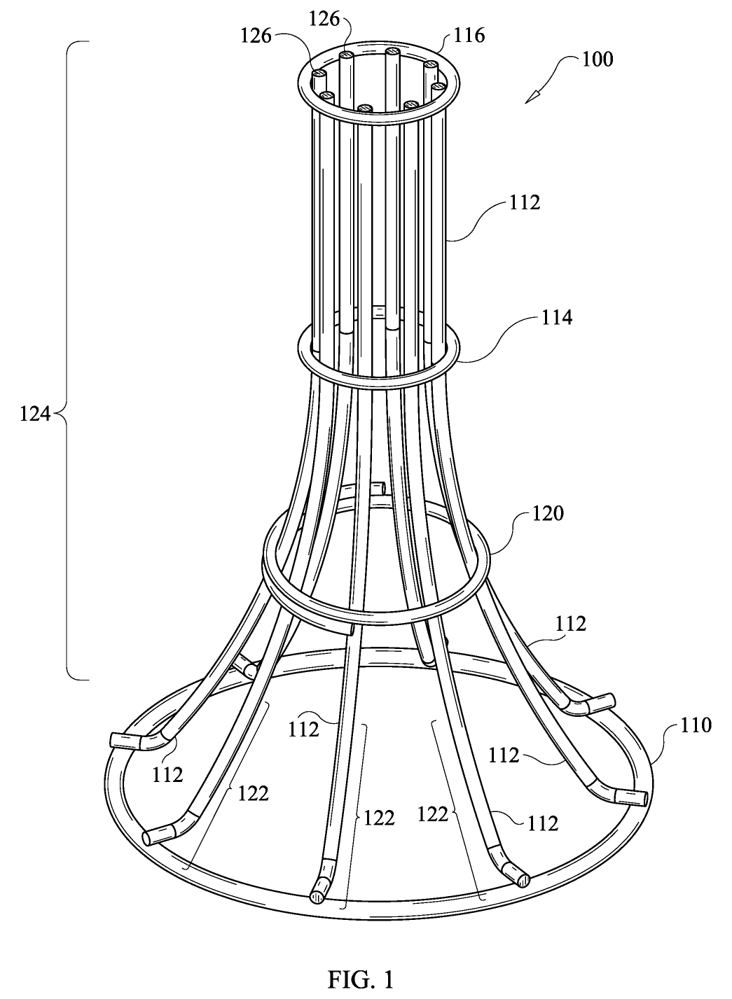

### Description of First Embodiment – FIGS. 1-5

FIG. 1 is a perspective view of a first embodiment of the inventive vertical poultry roasting rack which, in this case, is adequately sized and configured to support a roughly 2-to-8-pound chicken or duck.

The rack 100 of FIG. 1 comprises a large diameter base ring 110. Spaced equally around the circumference of base ring 110 are eight (8) evenly spaced vertically oriented wire rods 112, each of which extending upward from the base through a horizontally positioned center ring 114 to a horizontally positioned top ring 116. Each of the wire rods 112 is connected and held in place by means of welds to the base ring 110, center ring 114 and top ring 116. In this particular embodiment, the center ring 114 and top ring 116 are the same diameter and circumference and thus the connected wire rods extend straight upwards between the center ring 114 and the top ring 116. In alternative embodiments, the center ring may be wider than the top ring (as shown with respect to the second embodiment described below) and, thus, the wires would extend upwards at an angle. The relative size and circumference of the center and top rings is largely dependent on the size of the interior carcass of the poultry to be roasted. It is preferable that the top ring and center rings to be small enough to allow the carcass to slide down onto the rack but large enough so that the wire will be positioned evenly and adjacent to the interior meat of the poultry during roasting.

The embodiment shown in FIG. 1 includes additional, and optional, lower ring 120 or rings which may or may not be welded in place but which is sized to be located between the center ring 114 and the base ring 120. In this case, it is sized to fit down over the top and center rings and sit at a position which would be adjacent to the legs of the poultry when mounted on the rack. In alternative embodiments, there may be more than one lower ring 120. In alternative embodiments, the rings 120 and the spacing may be adjustable by increasing or decreasing the circumference of the lower ring(s) 120 though hook, bend, or other means understood in the industry such as but not limited to closeable gaps or wrapping (such as with an adjustable key holder). In alternative embodiments, the ring 120 or rings 120 will be sized to be placed in specific vertical positioning on the rack. In some alternative embodiments, the rings 120 will be positioned above the center and top rings or positioned immediately adjacent one another to provide additional searing heat to a specific location along the interior carcass.

Each wire rod and each of the several rings (top, center, lower, and base) is made of tempered steel, preferably of grade C-1008, and of a diameter of between .120 inches and .177 inches although different sizes and gauges are allowable depending on the size of the poultry to be roasted.

It should be understood that the material and relative gauge are important in assuring proper conductivity of heat into the interior of the poultry body. Tempered steel of grade C 1008 and of a diameter of between 1.20 and 1.77 inches is found to be ideal for conducting oven heat as well as for purposes of ensuring strength and cost conservation during manufacturing. While several prior art designs have utilized stainless steel as a way to reduce manufacturing costs, stainless steel is a relatively poor conductor of heat energy and Applicant finds that its use adds significantly to the length of time needed to roast the poultry and significantly reduces the ability to sear the interior of the poultry cavity within the first 20 – 30 minutes of roasting using normally accepted temperature settings for roasting poultry (standard roasting temperature settings) which is generally in a range of between 350 - 450-degrees Fahrenheit.

Looking at FIG. 1, each wire rod 112 has a lower portion 122 extending inward from the base ring 110 and then bending upward at an angle of approximately 35 to 60 degrees from the base ring and then continuing upward in a hyperbolic curve toward the center ring 114 and merging into a substantially vertical portion 124 terminating in upper ends 126 above the top ring 116. This lower portion 122 beginning in a relatively short and substantially horizontal portion before bending upward toward the center ring is important to allowing proper exposure of the wire rods to oven heat below the body of the mounted poultry. The increased exposure allows for additional heating of the rods which conduct searing heat up toward the lower carcass. And while some prior art designs utilize a “foot” (i.e. the wire is horizontal immediately at its connection with the base), the exposure to heat is inadequate particularly when used in conjunction with a wire made of relatively low energy conducting material such as stainless steel. The combination of using proper horizontal extension from the connection with the base to the bend upward, as shown in FIG. 1, is key to conducting adequate searing heat through the wire rods when roasting. Applicant finds that the combination as specified herein are optimal for roasting a 2-to-8-pound chicken under standard roasting temperature settings.

As shown, the first embodiment of FIG. 1 is for a chicken or duck sized carcass and has eight (8) evenly spaced vertically oriented wire rods 112 with relative spacing of 45 degrees. The number and spacing of the rods 112 contribute to the amount of searing heat that is conducted into the interior of the poultry cavity while roasting. In many prior art designs, the focus has been on simply having enough strength in design to adequately hold the poultry carcass in vertical position and rely on the air flow to heat the interior meat of the poultry body. In contrast, the present invention is focused on bringing adequate searing heat conducted through the wire to quickly sear the interior meat of the poultry thus maintaining the natural juices. So, while many third-party prior art designs generally utilize six (6) wire rods for any sized poultry, Applicant has determined over extensive trial and error that 8 evenly spaced rods are preferable for bringing adequate searing heat into the interior of the poultry cavity of a duck or chicken sized carcass to sear the interior of the poultry within the first 20-30 minutes using standard roasting temperature settings. Again, it is important to note that prior art designs are merely concerned with the structural support necessary to mount the carcass of a poultry vertically in the oven and not focused on the searing heat that is conducted through the wire rods to the interior of the carcass. It has been determined by the inventor over a significant period of testing and experimentation that the number of rods in conducting the appropriate amount of searing heat to the interior carcass and that 6 rods is generally ideal for a smaller poultry such as a game hen, 8 rods is generally ideal for a duck or chicken, and that the use of 10 rods is ideal for a turkey sized carcass. In alternative designs, additional vertical rods may be utilized to add searing heat where appropriate.

As shown in FIG. 1, the center ring 114 is smaller in diameter than the base ring 120 and generally the same size or sometimes slightly larger than the top ring 116. Each of the vertical rods 112 is welded to the base, center and top rings thus defining the substantially vertical upward curve of the substantially vertical rods 112 excepting that bottom portion of those rods, nearest the base ring extend inwards to create a substantially horizontal portion which, again, ensures proper exposure of the bottom portion of the rods when a poultry carcass is mounted on the rack.

The appropriate height and circumference of the rack 100 depends largely on the size (i.e. length and thickness) of the poultry carcass to be roasted. As previously explained, this first embodiment of the inventive design was designed specifically for roasting a 2-to-8-pound chicken or duck. For example, the height (base to top) of the rack shown in FIG. 1 is 7.75 inches and the height from the bottom of the center ring 114 to the top of the top ring 116 is about 3 inches.

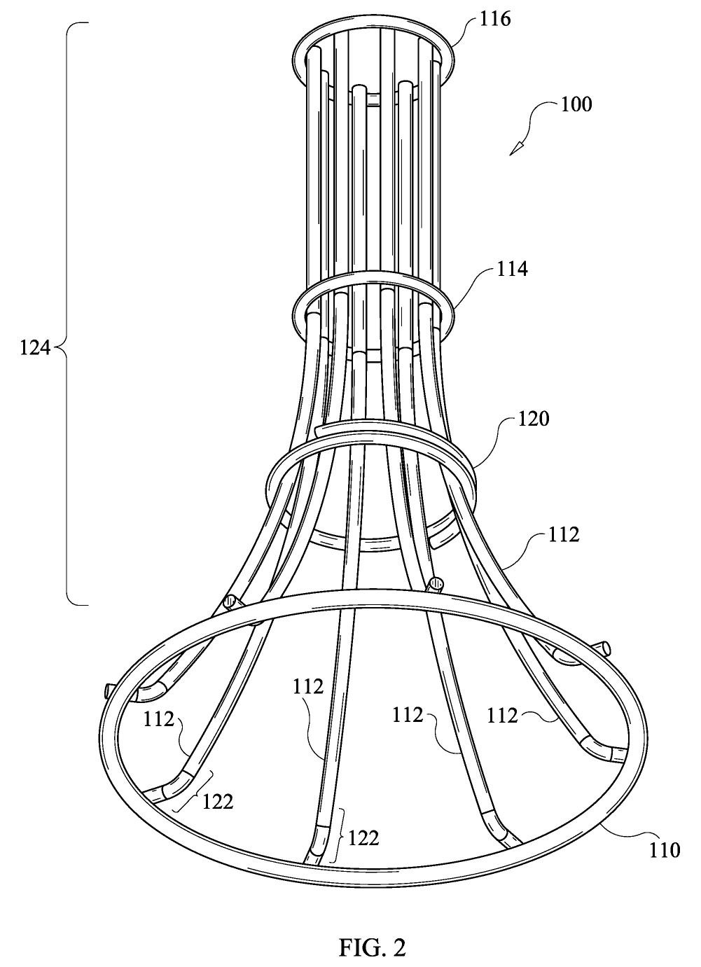

FIG. 2 is bottom perspective view of the first embodiment of the inventive vertical poultry roasting rack. This figure is helpful to understanding the preferred bend of the wire rods extending inward from the base and then extending upwards toward the center ring.

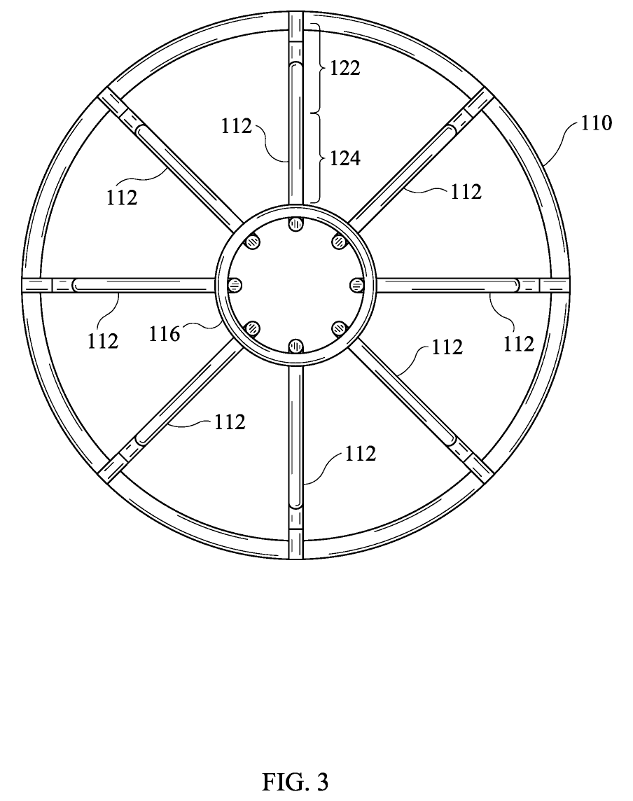

FIG. 3 is a top perspective view of the first embodiment of the inventive vertical poultry roasting rack. This figure highlights the relative positioning of the wire rods within the circumference of the base ring as well as the relative spacing of the wire rods 112 as they ascend from the base ring 110 through the center ring 114 to the top ring 116. The eight (8) wire rods, as shown, are spaced evenly and approximately 45 degrees away from one another and are farthest from one another in distance at the base. As they extend upward from the larger base ring 110 to the smaller center ring 114 (not visible in FIG. 3 but which is essentially the same circumference as the top ring 116), the wires extend closer together although they still maintain their relative distance from one another in terms of degrees. This means that as the wire rods extend upwards into the mounted body cavity of the poultry, they come closer in distance to apply searing heat to the interior carcass of the mounted poultry.

The spacing at the bottom portion 122 allows for adequate exposure of the wire rods below the mounted carcass to the heat of the oven or barbeque. This is particularly important absorbing conducting enough heat to adequately sear the lower portions of the poultry (in this case a chicken or duck) as previously described because the lower portions of the bird including the extending thighs and drumsticks generally require additional heat to sear in the natural juices and adequately cook those portions within the same time that it takes to complete cooking of the upper portions of the bird (including the breast portions which tend to dry out during cooking). One should note that the top ring 116 is also exposed to the heat of the oven or barbeque and serves to help conduct heat downward through the wire rods to the interior of the poultry carcass. When mounted, that area of the poultry carcass containing a relatively significant number capillaries is positioned at or near the center ring which serves to disperse the conducted heat more readily to that interior area of the poultry.

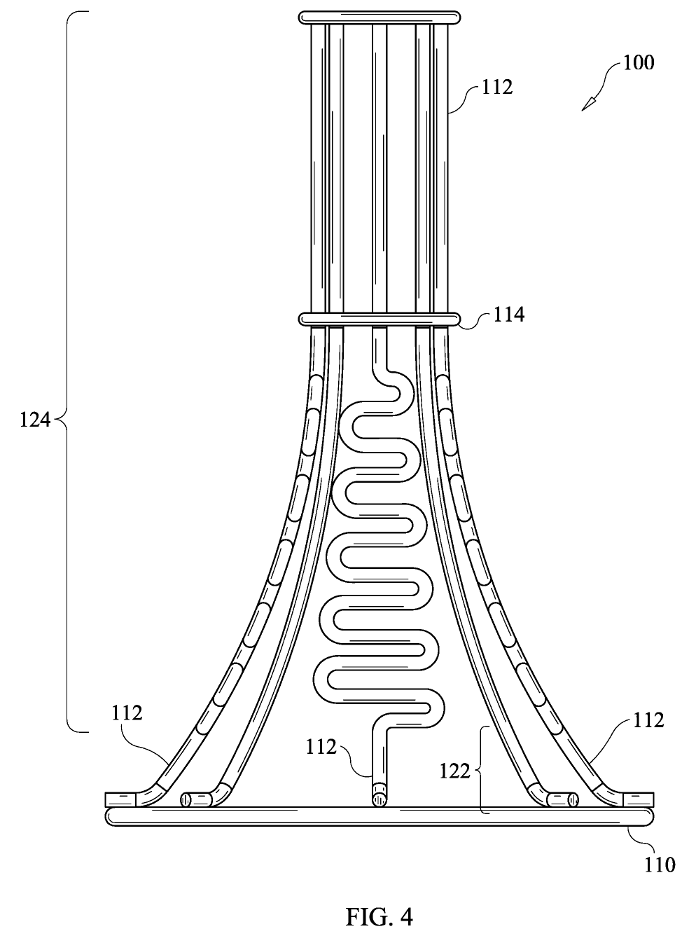

FIG. 4 is a schematic side elevation view of a variation of the first embodiment of the inventive vertical poultry roasting rack. This variation compensates for the increase in spacing between wire rods 112 (as shown in FIGS. 1-3) near the lower portion of the mounted poultry carcass. As shown, the design has been modified such that every other wire rod 112 is substantially curved within the horizontal plain to decrease the spacing between wire rods and allow for increased surface area of that portion of the rods which are in contact with or positioned immediately adjacent to the lower portions of the mounted poultry carcass. The lower portions 122 of the wire rods (extending below the increased curvature of this variant design) remain exposed and the searing heat is conducted upwards and more uniformly applied to the lower portions of the interior carcass thus searing juices in the bird and decreasing necessary cooking time for those lower portions which often cook more slowly than the upper portions. One should note that in the current embodiment, every other wire rod has the increased (side to side) curvature and surface area. This is just one option. Additional alternative embodiments might have each wire rod curving side to side to increase surface area in this location.

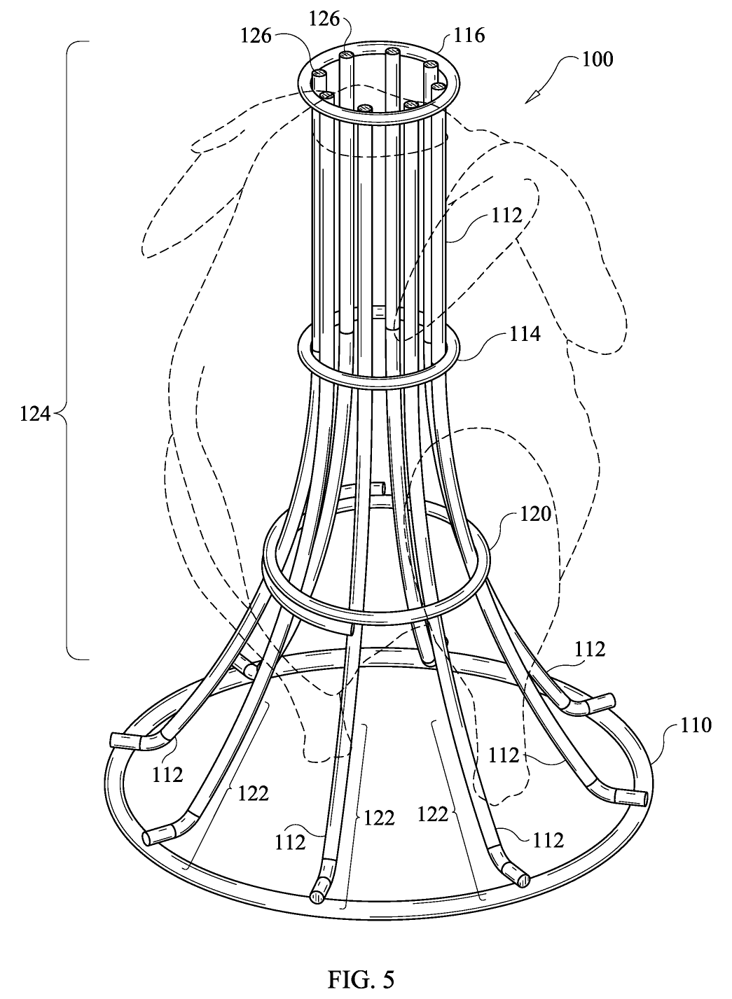

FIG. 5 is a schematic side elevation view of the first embodiment of the inventive vertical poultry roasting rack of FIGS. 1-3 showing the rack used to support poultry during roasting.

As described above, the principal use of the invention is to roast poultry (in this case a chicken or duck) in a substantially vertical position within an oven. While prior art designs are focused on allowing the natural juices of the poultry to flow out and downward so that they may be collected by a tray, the current invention is focused on searing the interior of the poultry body cavity during the first 20-30 minutes at standard cooking temperatures to maintain the natural juices within the carcass thus enhancing flavor and reducing overall cooking time. One will note that the lower portion 122 of the wire rods are left exposed to oven heat and not covered by the carcass. The positioning of the lower portion of the carcass (with legs/thighs) is generally at that portion of the rack where a lower ring might be positioned between the base ring and the center ring. The center ring is positioned generally at that point in the poultry carcass cavity where there are increased number of capillaries and the searing heat emanating from the center ring serves to sear those portions to seal in natural juices.

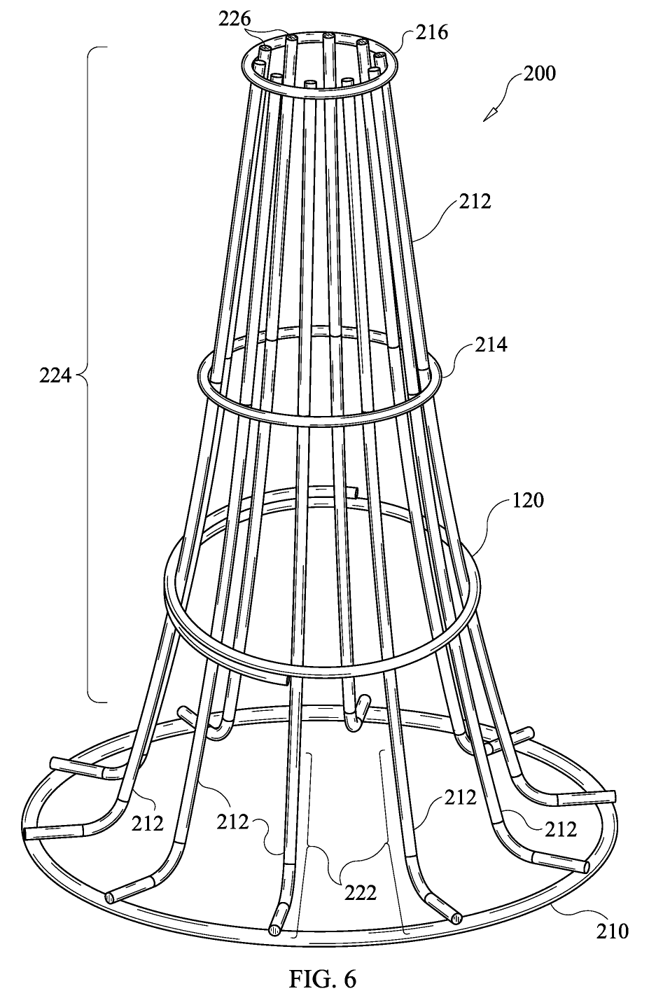

### Description of Second Embodiment – FIGS. 6-10

FIG. 6 is a perspective view of a second embodiment of the inventive vertical poultry roasting rack. This second embodiment vertical roasting rack 200 is similar in form, materials, focus, and function from the rack 100 of FIGS. 1-5 except for several important differences. Firstly, it is a larger rack designed for a larger poultry such as an 8-to-20 pound turkey. Secondly, the lower portion 222 has a substantially larger inward horizontal bend, and thirdly the upper portion 224 has a center ring 214 which is larger in circumference than the top ring 216 to accommodate wire rods 212 which extend downward from the top ring 216 at an angle to create a slightly increased circumference in the center of the bird.

The rack 200 of FIG. 6 comprises a large diameter base ring 210. Spaced equally around the circumference of ring 210 are ten (10) wire rods 212, each of which is in a substantially vertical plane extending upward through a horizontally positioned center ring 214 to a horizontally positioned top ring 216. The wire rods 212 are connected and held in place by means of welds to the base ring 218, center ring 214 and top ring 216.

The second embodiment shown may also include an optional lower ring (not shown) which may or may not be adjustable in size (circumference) by known means such as hook or overlapping bend but which is sized to fit over the top and center rings and is positioned between the center ring and the base ring preferably at a position which would be nearest to leg and thigh areas of a mounted poultry. As with optional lower ring 120, this ring may be alternatively welded in place. In a preferred embodiment, the one or more optional rings are sized to be easily placed over the top ring and dropped down onto the rack to rest between the center ring and the bottom ring. These optional rings are generally made of the same heat conductive material as the rest of the rack but could be thinner or larger in diameter than the other rack components if additional or lesser heat conductivity is desired. Further, the rings could be sized differently to allow resting at different locations along the vertical plain of the rack. As mentioned above, the rings could be overlapping to allow the circumference to be adjusted as is known in the art. But, preferably, they are closed circular rings that are sized to rest in locations on the rack where it would be beneficial to conduct additional searing heat to allow for searing of those locations on the interior of the carcass where there are exposed capillaries (such as where the heart and giblets were located) to prevent excess juices to flow out during cooking. It is noted by the inventor that in traditional cooking, the user would stuff the carcass with stuffing which would soak up the extra juices. In this form of vertical roasting the juices are largely maintained within the bird by searing these interior capillaries and exposed meat areas generally within the first 20-30 minutes of roasting.

Similar to the first embodiment shown in FIGS. 1-5, each wire rod 212 and the several rings (top, center, lower, and base) is preferably made of strong conductive material acceptable for use in roasting meat, such as tempered steel of grade C 1008, but may be made of other comparably energy conductive materials that are known in the art and acceptable for use in oven roasting such as aluminum or tungsten. As mentioned before, stainless steel has been used in some prior art designs concerned only with support and cost effectiveness but which has a relatively poor energy conductive quality and efficiency.

Looking at FIG. 6, each wire rod 212 has a substantially horizontal portion 222 extending inward from the base ring 220 for one to two inches before bending upward and at an angle of approximately 40-80 degrees to toward the center ring 214 and then continuing at the same general angle to the top ring 216.

In the preferred second embodiment shown, the ten (10) evenly spaced vertically oriented wire rods 212 are spaced 36 degrees apart. As with the first embodiment, the number and spacing of the wire rods 212 determines (at least in part) the amount of searing heat that is conducted through the wire rods 212 into the interior of the poultry (in this case a turkey) during roasting. In a number of prior art designs, the focus has been on strength of structure and cost effectiveness in holding the poultry in a vertical position and, thus, only 6 wire rods were utilized. In contrast, the present invention is concerned with providing greater searing heat to the interior meat of the poultry, particularly the larger sized birds such as duck, chicken and turkey during roasting and Applicant has determined, through significant trial and error, that 8-12 wire rods are preferred for conducting enough heat and effectively searing in natural juices of a mounted poultry within the first 20-30 minutes using standard roasting temperature settings. Specifically, it has been determined that 8 rods are preferrable for duck and chicken sized carcasses and that 10 rods are preferable for turkey sized carcasses. For smaller carcasses, such as game hens, the 6-rod rack may be adequate as long as the rods are made of appropriately conductive materials of the diameters discussed in this specification. As noted above, third party prior art designs are not focused on conducting searing heat but instead are only concerned about using materials of type and size which provide structural strength and minimize cost. The present invention is concerned with conducting appropriate searing heat to the interior of the carcass to ensure proper searing and maintenance of natural juices within the carcass to provide for enhanced flavor, preserve tenderness, and preventing excess drying of the meat during the cooking process.

As shown in FIG. 6, the center ring 214 is smaller in diameter than the base ring 220 and larger in size than the top ring 216. Like the first embodiment, each of the vertical rods 212 is held in position by welds to the top, center, and base rings.

The preferred measurements (height and circumference) of the rack 200 depends on the size of the poultry to be roasted. This second embodiment of the inventive design was sized to mount a 20-pound turkey. The height (base to top) of the rack shown in FIG. 6 is approximately 9.74 inches. The height from the bottom surface of the center ring 224 to the top of the top ring 216 is approximately 4 inches.

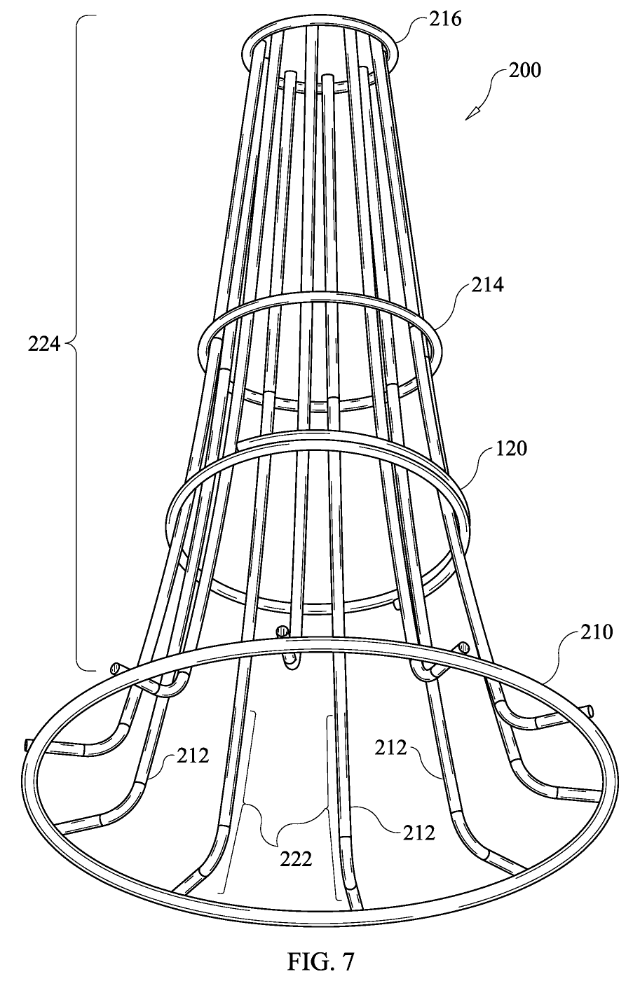

FIG. 7 is a bottom perspective view of the second embodiment of the inventive vertical poultry roasting rack. It is helpful for understanding the preferred relative bend in the wire rods 212 as they extend from the base ring 210 towards the center ring 214.

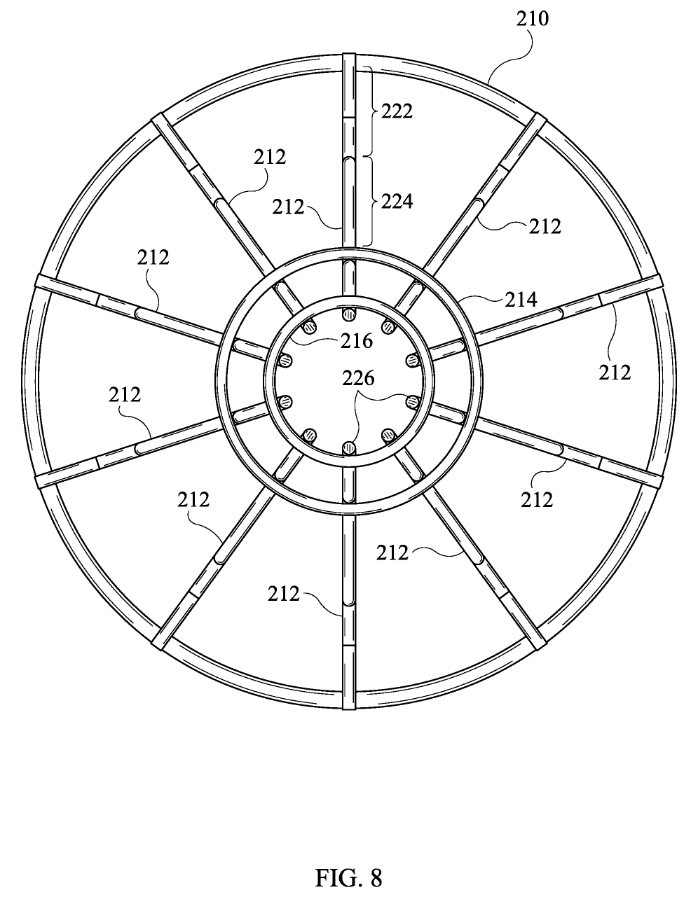

FIG. 8 is a top perspective view of the second embodiment of the inventive vertical poultry roasting rack. This figure highlights the relative positioning of the wire rods 212 within the circumference of the base ring 218 as well as the shape and relative spacing of the wire rods as they ascend upward toward the center ring 214. This second embodiment utilizes ten (10) evenly spaced wire rods 212 of similar diameter to those used in the first embodiment described in FIGS. 1-6.

In this second embodiment, however, the wires are spaced approximately 36 degrees away from one another. As they extend upward from the base ring 218 to the center ring 214, they maintain their relative spacing but move closer together because the center ring 214 is smaller in circumference to that of the base ring 218. One should note that the center ring 214 of this second embodiment is larger in circumference than the top ring 216 which is not the case in the first embodiment where the top ring 116 is relatively the same size as the center ring 114. Thus, in this second embodiment, the wire rods 212 remain at an angle as they extend from the center ring 214 to the top ring 216. Further, the bottom portion 222 of the wire rods 212 extend inward from the base ring at an angle of 10 to 20 degrees before bending and extending upward at an approximate angle of 40 to 80 degrees. This is to create greater exposure of the wire rods to the oven heat at the bottom portion (as the bend creates a relatively longer overall length and allows for a base that will support a larger poultry (such as a turkey) without easily tipping. The longer overall length at the base portion 222 allows for greater absorption of heat and increased conductivity of heat upward into the lower cavity portions of the mounted poultry carcass.

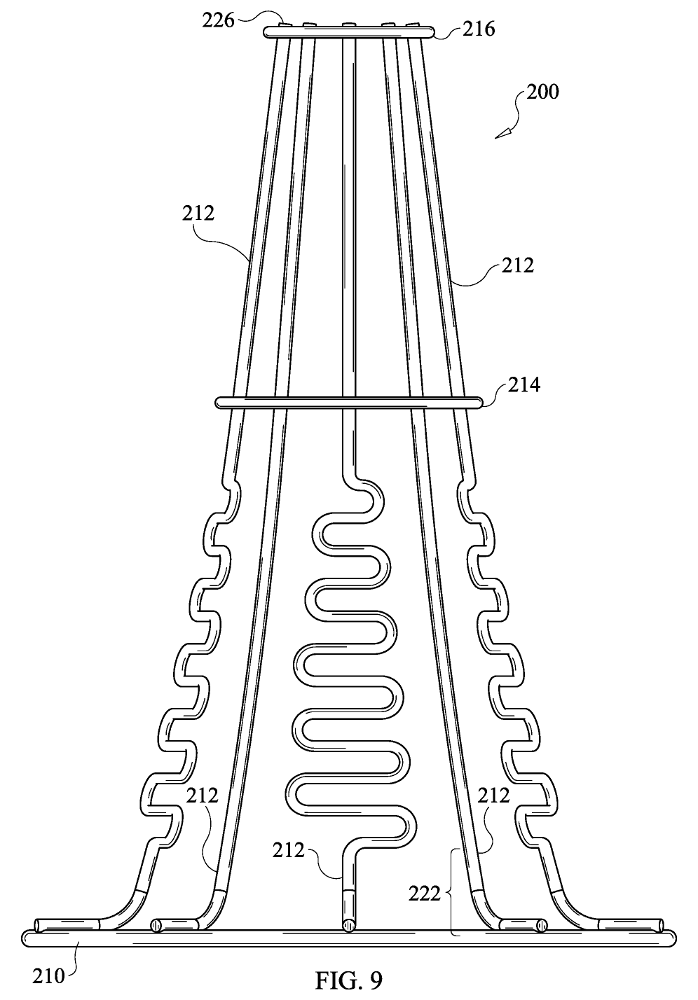

FIG. 9 is a schematic side elevation view of a variation of the second embodiment of the inventive vertical poultry roasting rack. This variation of the second embodiment compensates for the increase in spacing of the wire rods covered by the lower portions of the poultry carcass by providing oscillating curves in horizontal plane between the center ring 214 and the base ring 210 in every other wire rod 212 to provide for greater surface area of the rods 212 immediately adjacent the lower portions of the mounted carcass as similarly shown with respect to the variation of the first embodiment depicted in FIG. 4 but in this case the curves are not as severe as those shown for the first embodiment. As for the first embodiment, the second embodiment provides for an optional lower ring (not shown) which is sized to fit over the top and center rings and sit down on the vertical rods between the center ring and the base ring to provide additional searing to the lower portions of the poultry when mounted.

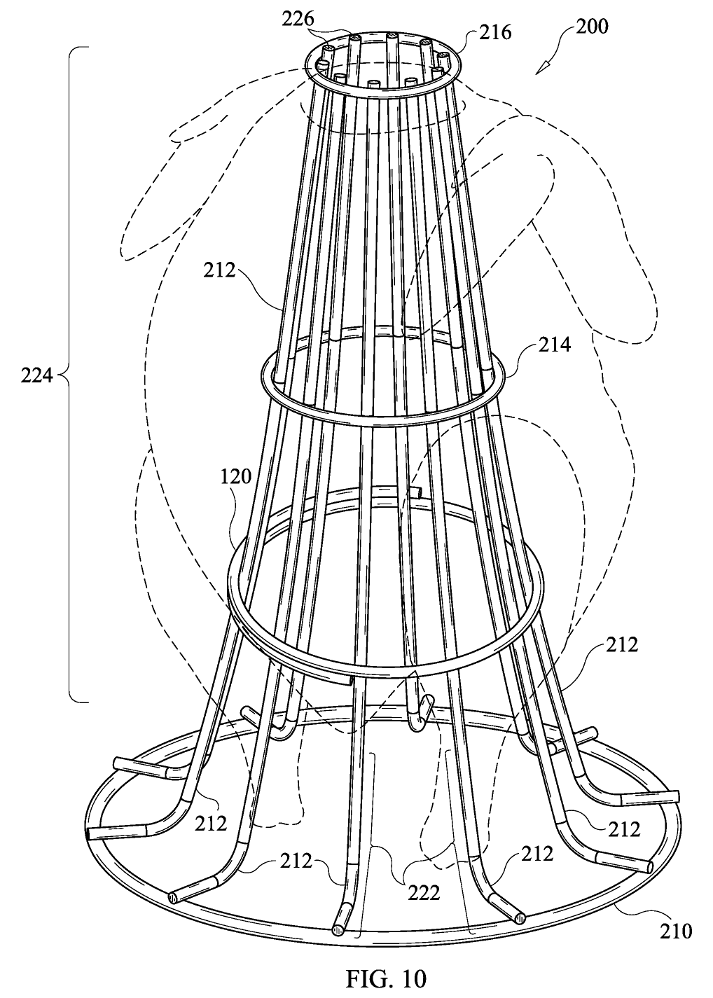

FIG. 10 is a schematic side elevation view of the second embodiment of the inventive poultry roasting rack of FIGS. 6 -8 showing the rack supporting a relatively larger poultry (such as a turkey) during roasting. It should be noted that the optional lower ring 220 is adjustable and can be positioned down onto the rack from the top or otherwise wrapped around the rack and fixed in position by sizing of the circumference relative to the width of the rack at a specific location or by using adjustable latching means known in the industry. The lower ring 220 is positioned at that location where the poultry sits down onto the rack so that the interior carcass nearest the legs/thighs is immediately adjacent to the lower ring 220 which conducts additional searing heat to that location thus decreasing the amount of time needed to cook that area. The optional lower ring 120 functions in the same way on the smaller rack described above (See FIGS. 1-5). The optional lower rings 120 and 220 may be fixed (welded) to the rack but, as shown, Applicant prefers that they be optional and thus not fixed permanently so they may be adjusted in size and position on the lower portion of the rack. In some alternatives, the rings 120 and 220 are fixed in circumference and sized to fit down onto the rack in specific locations without adjustment or fixing them to the vertical rods. In some cases, user may prefer not to use the optional lower ring at all. In some cases, several optional rings may be used at a specific location. It should be noted that increased conductivity in the lower portions of the rack can also be achieved by making the lower portions (122 and 222) of the wire rods out of a material with greater conductivity than the longer upper portions (124 and 224). For example, the lower portions might be made of Aluminum and the upper portions out of tempered steel. Or, optionally, the lower portions may have a coating applied which is made of material of greater conductivity. The point is that the lower exposed portions need to heat up substantially and quickly to conduct heat upward into the interior cavity of the poultry to more quickly and thoroughly sear the interior lower portions of the carcass during the first 20-30 minutes of roasting. In some alternative embodiments, additional removable rings may be positioned between the top and center rings. In some alternative embodiments, the additional rings may be fixedly placed on the rack at various positions between the top and base rings depending on the areas where the interior of the poultry carcass requires the most searing heat to produce adequate roasting of all meat on the poultry carcase.

### Method for Making:

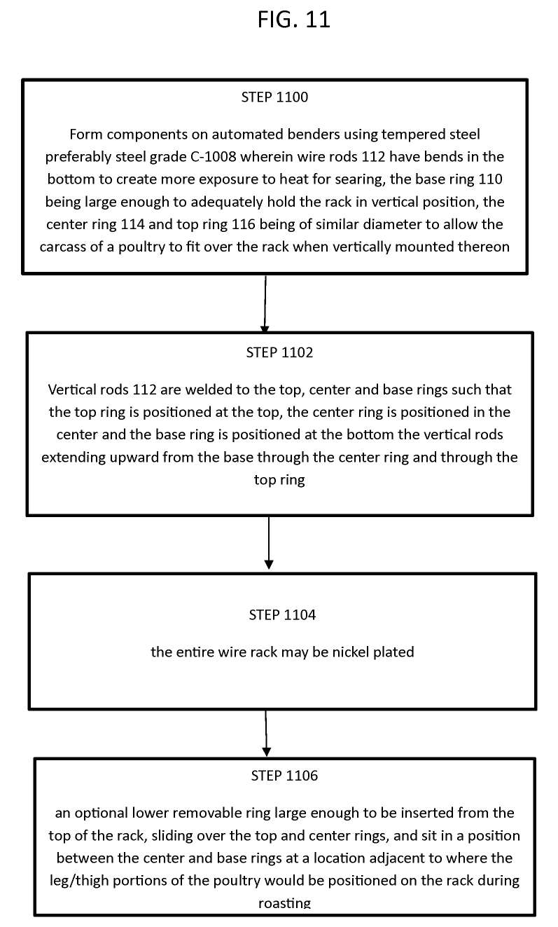

FIG. 11 is a flow chart showing the steps for making the first embodiment of the inventive vertical poultry roasting rack shown in FIGS. 1-5.

The invention includes a method for making a vertical roasting rack for supporting a chicken or duck within an oven during roasting, the rack comprising at least horizontally oriented base ring, center ring, top ring with eight (8) or more evenly spaced vertically oriented wire rods extending from the base ring, to through the center ring and to the top ring utilizing the following steps:

In a step 1100, form components on automated benders using tempered steel preferably steel grade C-1008 wherein wire rods 112 have bends in the bottom to create more exposure to heat for searing, the base ring 110 being large enough to adequately hold the rack in vertical position, the center ring 114 and top ring 116 being of similar diameter to allow the carcass of a poultry to fit over the rack when vertically mounted thereon;

In a step 1102, vertical rods 112 are welded to the top, center and base rings such that the top ring is positioned at the top, the center ring is positioned in the center and the base ring is positioned at the distal end of the bottom portion of the vertical rods extending upward from the base through the center ring and through the top ring; and

In a step 1104, the entire wire rack may be nickel plated and then, optionally, chrome plated. In some cases, a non-stick coating may then be applied at this step.

In an alternative step 1106, one or more optional lower removable rings large enough to be inserted from the top of the rack, sliding over the top and center rings, and sit in a position between the center and base rings at a location adjacent to where the leg/thigh portions of the poultry would be positioned on the rack during roasting. In other alternatives, additional rings sized to be positioned onto the rack in the position where the heart of giblets of the carcass would have been positioned before removal. In alternative methods, the rings could be removed or repositioned during the cooking process.

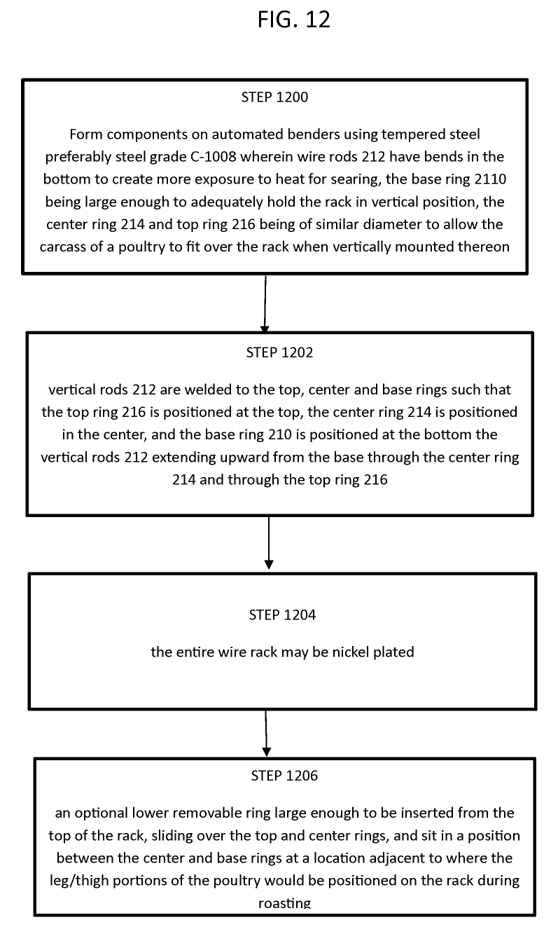

FIG. 12 is a flow chart showing the steps for making the second embodiment of the inventive vertical poultry roasting rack shown in FIGS. 6-10.

In a step 1200, form components on automated benders using tempered steel preferably steel grade C-1008 wherein wire rods 212 have bends in the bottom to create more exposure to heat for searing, the base ring 2110 being large enough to adequately hold the rack in vertical position, the center ring 214 and top ring 216 being of similar diameter to allow the carcass of a poultry to fit over the rack when vertically mounted thereon;

In a step 1202, vertical rods 212 are welded to the top, center and base rings such that the top ring 216 is positioned at the top, the center ring 214 is positioned in the center, and the base ring 210 is positioned at the bottom the vertical rods 212 extending upward from the base through the center ring 214 and through the top ring 216; and

In a step 1204, the entire wire rack may be nickel plated.

### Method for Using:

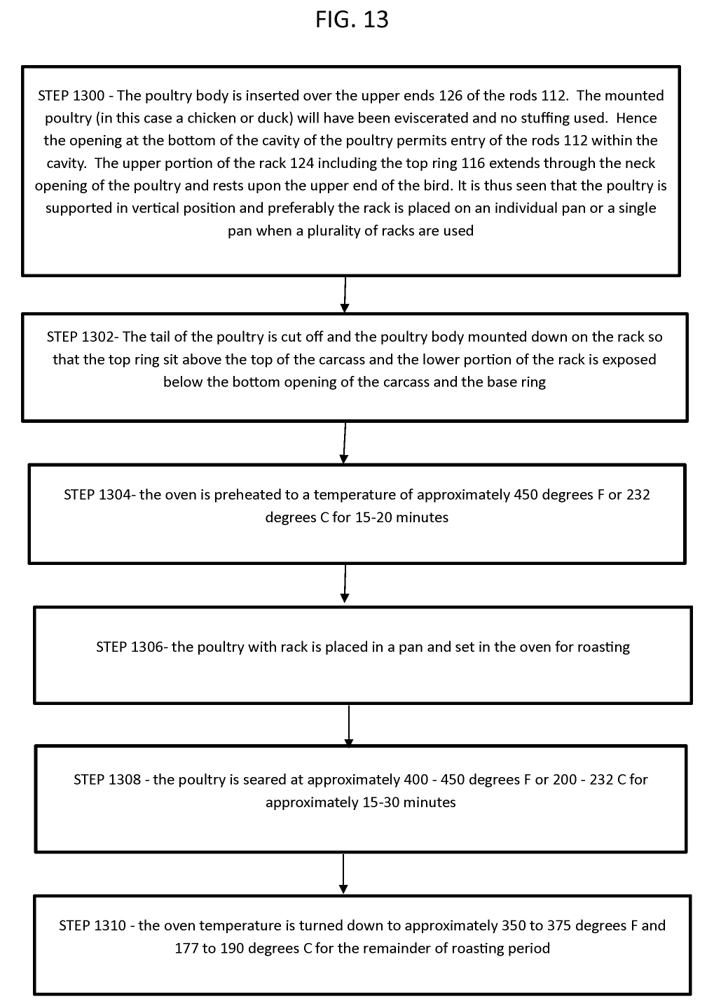

FIG. 13 is a flow chart showing the steps for using the inventive vertical poultry roasting rack.

### A method for using the inventive roasting rack comprises the following steps:

In a step 1300, the poultry body is inserted over the upper ends 126 of the rods 112. The mounted poultry (in this case a chicken or duck) will have been eviscerated and no stuffing used. Hence the opening at the bottom of the cavity of the poultry permits entry of the rods 112 within the cavity. The upper portion of the rack 124 including the top ring 116 extends through the neck opening of the poultry and rests upon the upper end of the bird. It is thus seen that the poultry is supported in vertical position and preferably the rack is placed on an individual pan or a single pan when a plurality of racks are used. In an alternative method, one or more optional, adjustable, or otherwise removable rings are placed onto the rack to rest on the rack between the center ring and the bottom ring (as discussed numerous times in the discussion above) to allow for greater searing of the interior carcass during the roasting process.

The vertical position of the carcass on the rack permits oven heat to extend upward through the interior cavity. Also, the opening being downward and the wires of the rods 112 conducting the heat upwardly and inwardly to sear the interior meat of the body. Thus, the poultry is cooked both from the inside and outside as with prior art designs but the conduction of additional heat through the rods 112 sears the interior of the body more quickly than if the interior body was just exposed to air oven heat. In this way, the meat is cooked evenly while a majority of the juices and water are retained within the meat during the cooking process.

In a step 1302, the tail of the poultry is cut off and the poultry body mounted down on the rack so that the top ring is exposed above the top of the carcass and the lower portion of the rack is exposed below the bottom opening of the carcass and the base ring.

In a step 1304, the oven is preheated to a temperature of approximately 450 degrees F or 232 degrees C for 15-20 minutes.

In a step 1306, the poultry with rack is placed in a pan and set in the oven for roasting.

In a step 1308, the poultry is seared at approximately 400 - 450 degrees F or 200 - 232 C for approximately 15-30 minutes.

In a step 1310, the oven temperature is turned down to approximately 350 to 375 degrees F and 177 to 190 degrees C for the remainder of roasting period.

From the foregoing it will be appreciated that, although specific embodiments have been described herein for purposes of illustration, various modifications may be made without deviating from the spirit and scope of the teachings. The exemplary descriptions provided herein do not preclude other implementations and use cases not described in detail. The elements and function may vary, as there are a variety of ways the roasting rack described herein may be implemented within the scope of the invention. Accordingly, the claims are not limited by the disclosed embodiments.

What is claimed is:

1. A poultry vertical roasting rack comprising:
top, center and base horizontally oriented rings mounted to a plurality of vertical rods, each rod having upper, central, and lower portions,
each of the horizontally oriented rings having outwardly facing, inwardly facing, top facing, and bottom facing circumferences,
each of the rods spaced evenly around the bottom facing circumference of the base ring and secured thereto,
each of the rods spaced evenly around the inwardly facing circumferences of the center and top rings and secured thereto,
each of the rods extending inwardly and upwardly from said base ring in a substantially vertical hyperbolic arc, connecting at the center portion with the center ring and at the top portion with the top ring,
the bottom ring being substantially larger in diameter than the center and top rings,
the curvature of the rods extending from the base inward and then upward in a horizontal angle relative the diameters of the base, center and top rings,
wherein the bottom portion of the inwardly extending rods remain substantially exposed to heat when a poultry carcass is placed vertically on the roasting rack such that the rods may serve to conduct heat upward toward the center ring and into the interior of the poultry carcass during a roasting process.

2. The rack of claim 1 wherein the bottom portion of the rods extend inwardly from the base ring at an angle of approximately 35 to 60 degrees before curving upward in a hyperbolic arc toward the center ring.

3. The rack of claim 1 wherein at middle portion of the rods extend between the center and top rings at an angle between 60 and 90 degrees.

4. The rack of claim 1 wherein the bottom portion of the rods are made of a material that has a heat conducting value greater than the material making up the center and top portions.

5. The rack of claim 1 wherein bottom portions of every other rod has horizontal bends to create greater surface area contact with an interior portion of a poultry carcass when mounted on the rack.

6. The rack of claim 1 having an additional removable ring with circumference greater than the top ring which may be placed over the top ring and rest on the vertical rods between the center ring and the bottom ring allowing for increased conductivity of heat to the inner carcass of a mounted poultry.
